(19) United States
(12) Patent Application Publication
(10) Pub. No.: US 2016/0250594 A1
(43) Pub. Date: Sep. 1, 2016

(54) PASSIVE NOx ADSORBER

(71) Applicant: Johnson Matthey Public Limited Company, London (GB)

(72) Inventors: John Leonello CASCI, Royston (GB); Jillian Elaine COLLIER, Royston (GB); Geraint Kingsley LLOYD, Royston (GB)

(21) Appl. No.: 15/054,195

(22) Filed: Feb. 26, 2016

Related U.S. Application Data
(60) Provisional application No. 62/120,976, filed on Feb. 26, 2015.

(51) Int. Cl. B01D 53/94; F01N 3/08

(52) U.S. Cl. CPC B01D 53/9481; F01N 3/0842; F01N 3/0885; B01D 2255/50; B01D 2255/1023

(57) ABSTRACT

A passive NOₓ adsorber is disclosed. The passive NOₓ adsorber is effective to adsorb NOₓ at or below a low temperature and release the adsorbed NOₓ at temperatures above the low temperature. The passive NOₓ adsorber comprises a noble metal and a molecular sieve having a MAZ Framework Type. The invention also includes an exhaust system comprising the passive NOₓ adsorber, and a method for treating exhaust gas from an internal combustion engine utilizing the passive NOₓ adsorber.

### CROSS-REFERENCE TO RELATED APPLICATIONS

This application claims priority benefit to U.S. Provisional Patent Application No. 62/120,976, filed on Feb. 26, 2015, which is incorporated herein by reference.

### FIELD OF THE INVENTION

The invention relates to a passive NOₓ adsorber and its use in an exhaust system for internal combustion engines.

### BACKGROUND OF THE INVENTION

Internal combustion engines produce exhaust gases containing a variety of pollutants, including nitrogen oxides (“NOₓ”), carbon monoxide, and uncombusted hydrocarbons. These emissions are the subject of governmental legislation. Emission control systems are widely utilized to reduce the amount of these pollutants emitted to atmosphere, and typically achieve very high efficiencies once they reach their operating temperature (typically, 200° C. and higher). However, these systems are relatively inefficient below their operating temperature (the “cold start” period).

For instance, current urea based selective catalytic reduction (SCR) applications implemented for meeting Euro 6b emissions require that the temperature at the urea dosing position be above about 180° C. before urea can be dosed and used to convert NOₓ. NOₓ conversion below 180° C. is difficult to address using the current systems, and future European and US legislation will stress the low temperature NOₓ storage and conversion. Currently this is achieved by heating strategies but this has a detrimental effect of CO₂ emissions.

As even more stringent national and regional legislation lowers the amount of pollutants that can be emitted from diesel or gasoline engines, reducing emissions during the cold start period is becoming a major challenge. Thus, methods for reducing the level of NOₓ emitted during cold start condition continue to be explored.

For instance, PCT Intl. Appl. WO 2008/047170 discloses a system wherein NOₓ from a lean exhaust gas is adsorbed at temperatures below 200° C. and is subsequently thermally desorbed above 200° C. The NOₓ adsorbent is taught to consist of palladium and a cerium oxide or a mixed oxide or composite oxide containing cerium and at least one other transition metal.

U.S. Appl. Pub. No. 2011/0005200 teaches a catalyst system that simultaneously removes ammonia and enhances net NOₓ conversion by placing an ammonia-selective catalytic reduction (“NH₃—SCR”) catalyst formulation downstream of a lean NOₓ trap. The NH₃—SCR catalyst is taught to adsorb the ammonia that is generated during the rich pulses in the lean NOₓ trap. The stored ammonia then reacts with the NOₓ emitted from the upstream lean NOₓ trap, which increases NOₓ conversion rate while depleting the stored ammonia. PCT Intl. Appl. WO 2004/076829 discloses an exhaust-gas purification system which includes a NOₓ storage catalyst arranged upstream of an SCR catalyst. The NOₓ storage catalyst includes at least one alkali, alkaline earth, or rare earth metal which is coated or activated with at least one platinum group metal (Pt, Pd, Rh, or Ir). A particularly preferred NOₓ storage catalyst is taught to include cerium oxide coated with platinum and additionally platinum as an oxidizing catalyst on a support based on aluminum oxide. EP 1027919 discloses a NOₓ adsorbent material that comprises a porous support material, such as alumina, zeolite, zirconia, titania, and/or lanthana, and at least 0.1 wt % precious metal (Pt, Pd, and/or Rh). Platinum carried on alumina is exemplified. U.S. Appl. Pub. No. 2012/0308439 A1 teaches a cold start catalyst that comprises (1) a zeolite catalyst comprising a base metal, a noble metal, and a zeolite, and (2) a supported platinum group metal catalyst comprising one or more platinum group metals and one or more inorganic oxide carriers.

Co-pending U.S. Pat. Appl. No. discloses a passive NOₓ adsorber (PNA) that comprises a noble metal and a small pore molecular sieve such as chabazite (CHA). Although noble metal/zeolite PNA catalysts such as Pd/CHA and Pd/Beta show good NOₓ storage performance and improved sulfur tolerance compared to non-zeolite PNAs, the temperature at which the NOₓ is released is too low for the downstream SCR component to convert all of the NOₓ to N₂.

As with any automotive system and process, it is desirable to attain still further improvements in exhaust gas treatment systems, particularly under cold start conditions. We have discovered a new passive NOₓ adsorber that provides enhanced cleaning of the exhaust gases from internal combustion engines. The new passive NOₓ adsorber not only increases the NOₓ release temperature but also increases the total NOₓ storage capacity.

### SUMMARY OF THE INVENTION

The invention is a passive NOₓ adsorber that is effective to adsorb NOₓ at or below a low temperature and release the adsorbed NOₓ at temperatures above the low temperature. The passive NOₓ adsorber comprises a first noble metal and a molecular sieve having a MAZ framework. The invention also includes an exhaust system comprising the passive NOₓ adsorber, and a method for treating exhaust gas from an internal combustion engine utilizing the passive NOₓ adsorber.

### BRIEF DESCRIPTION OF THE DRAWING

FIG. 1 shows the NOx storage and release vs. time profiles for a PNA of the invention and a comparative PNA.

### DETAILED DESCRIPTION OF THE INVENTION

The passive NOₓ adsorber of the invention is effective to adsorb NOₓ at or below a low temperature and release the adsorbed NOₓ at temperatures above the low temperature. Preferably, the low temperature is about 250° C. The passive NOₓ adsorber comprises a first noble metal and a molecular sieve having a MAZ Framework Type. The first noble metal is preferably palladium, platinum, rhodium, gold, silver, iridium, ruthenium, osmium, or mixtures thereof; more preferably, palladium, platinum, rhodium, or mixtures thereof. Palladium is particularly preferred.

The molecular sieve has a MAZ Framework Type and may be any natural or a synthetic molecular sieve, including zeolites, and is preferably composed of aluminum, silicon, and/or heteroatoms (e.g., Ga) and has a MAZ framework. The MAZ molecular sieve typically has a three-dimensional arrangement of TO₄ (T=Si, Al, Ga) units or tetrahedra that are joined by the sharing of oxygen atoms, and are characterised by a channel system based on a 1-dimensional 12-ring channel and an independent 3-dimensional 8-ring channel system. The designations such as 12-ring and 8-ring refer to the number of tetrahedral atoms (e.g., Si, Al) or oxygen atoms that make up a ring system. Molecular sieve frameworks are typically anionic, which are counterbalanced by charge compensating cations, typically alkali and alkaline earth elements (e.g., Na, K, Mg, Ca, Sr, and Ba), ammonium ions, and also protons. Other metals (e.g., Fe, Ti) may be incorporated into the framework of the MAZ molecular sieve to produce a metal-incorporated molecular sieve.

Preferably, the MAZ-framework molecular sieve is an aluminosilicate zeolite or a metal-substituted aluminosilicate zeolite. More preferably, the MAZ-framework molecular sieve is ZSM-4, LZ-202, mazzite, or omega zeolite.

The passive NOₓ adsorber may be prepared by any known means. For instance, the first noble metal may be added to the MAZ-framework molecular sieve to form the passive NOₓ adsorber by any known means, the manner of addition is not considered to be particularly critical. For example, a noble metal compound (such as palladium nitrate) may be supported on the molecular sieve by impregnation, adsorption, ion-exchange, incipient wetness, precipitation, spray drying, or the like. Alternatively, the noble metal may be added during molecular sieve synthesis. Other metals may also be added to the passive NOₓ adsorber.

Preferably, the passive NOₓ adsorber further comprises a flow-through substrate or filter substrate. The flow-through or filter substrate is a substrate that is capable of containing catalyst components. The substrate is preferably a ceramic substrate or a metallic substrate. The ceramic substrate may be made of any suitable refractory material, e.g., alumina, silica, titania, ceria, zirconia, magnesia, zeolites, silicon nitride, silicon carbide, zirconium silicates, magnesium silicates, aluminosilicates, metallo aluminosilicates (such as cordierite and spudomene), or a mixture or mixed oxide of any two or more thereof. Cordierite, a magnesium aluminosilicate, and silicon carbide are particularly preferred.

The metallic substrates may be made of any suitable metal, and in particular heat-resistant metals and metal alloys such as titanium and stainless steel as well as ferritic alloys containing iron, nickel, chromium, and/or aluminum in addition to other trace metals.

The flow-through substrate is preferably a flow-through monolith having a honeycomb structure with many small, parallel thin-walled channels running axially through the substrate and extending throughout from an inlet or an outlet of the substrate. The channel cross-section of the substrate may be any shape, but is preferably square, sinusoidal, triangular, rectangular, hexagonal, trapezoidal, circular, or oval.

The filter substrate is preferably a wall-flow monolith filter. The channels of a wall-flow filter are alternately blocked, which allow the exhaust gas stream to enter a channel from the inlet, then flow through the channel walls, and exit the filter from a different channel leading to the outlet. Particulates in the exhaust gas stream are thus trapped in the filter.

The passive NOₓ adsorber may be added to the flow-through or filter substrate by any known means. A representative process for preparing the passive NOₓ adsorber using a washcoat procedure is set forth below. It will be understood that the process below can be varied according to different embodiments of the invention.

The pre-formed passive NOₓ adsorber may be added to the flow-through or filter substrate by a washcoating step. Alternatively, the passive NOₓ adsorber may be formed on the flow-through or filter substrate by first washcoating unmodified molecular sieve onto the substrate to produce a molecular sieve-coated substrate. Noble metal may then be added to the molecular sieve-coated substrate, which may be accomplished by an impregnation procedure, or the like.

The washcoating procedure is preferably performed by first slurrying finely divided particles of the passive NOₓ adsorber (or unmodified MAZ-framework molecular sieve) in an appropriate solvent, preferably water, to form the slurry. Additional components, such as transition metal oxides, binders, stabilizers, or promoters may also be incorporated in the slurry as a mixture of water soluble or water-dispersible compounds. If unmodified MAZ-framework molecular sieve is utilized in the slurry, a noble metal compound (such as palladium nitrate) may be added into the slurry in order to form the noble metal/MAZ-framework molecular sieve during the washcoating process.

The slurry preferably contains between 10 to 70 weight percent solids, more preferably between 20 to 50 weight percent. Prior to forming the slurry, the passive NOₓ adsorber (or unmodified MAZ-framework molecular sieve) particles are preferably subject to a size reduction treatment (e.g., milling) such that the average particle size of the solid particles is less than 20 microns in diameter.

The flow-through or filter substrate may then be dipped one or more times into the slurry or the slurry may be coated on the substrate such that there will be deposited on the substrate the desired loading of catalytic materials. If the first noble metal is not incorporated into the MAZ-framework molecular sieve prior to, or during, washcoating the flow-through or filter substrate, the molecular sieve-coated substrate is typically dried and calcined and then, the first noble metal may be added to the molecular sieve-coated substrate by any known means, including impregnation, adsorption, or ion-exchange, for example, with a noble metal compound (such as palladium nitrate).

The passive NOₓ adsorber coating can cover the total length of the substrate, or alternately can only cover a portion of the total length of the substrate such that only an inlet zone or outlet zone of passive NOₓ adsorber coating is formed. Preferably, the entire length of the substrate is coated with the passive NOₓ adsorber slurry so that a washcoat of the passive NOₓ adsorber covers the entire surface of the substrate.

After the flow-through or filter substrate has been coated with the passive NOₓ adsorber, and impregnated with noble metal if necessary, the coated substrate is preferably dried and then calcined by heating at an elevated temperature to form the passive NOₓ adsorber-coated substrate. Preferably, the calcination occurs at 400 to 600° C. for approximately 1 to 8 hours.

In an alternative embodiment, the flow-through or filter substrate is comprised of the passive NOₓ adsorber. In this case, the passive NOₓ adsorber is extruded to form the flow-through or filter substrate. The passive NO adsorber extruded substrate is preferably a honeycomb flow-through monolith. Extruded molecular sieve substrates and honeycomb bodies, and processes for making them, are known in the art. See, for example, U.S. Pat. Nos. 5,492,883, 5,565,394, and 5,633,217 and U.S. Pat. No. Re. 34,804. Typically, the molecular sieve material is mixed with a permanent binder such as silicone resin and a temporary binder such as methylcellulose, and the mixture is extruded to form a green honeycomb body, which is then calcined and sintered to form the final small pore molecular sieve flow-through monolith. The molecular sieve may contain the first noble metal prior to extruding such that a passive NOₓ adsorber monolith is produced by the extrusion procedure. Alternatively, the first noble metal may be added to a pre-formed molecular sieve monolith in order to produce the passive NOₓ adsorber monolith.

Additionally, the passive NOₓ adsorber may further comprise a second molecular sieve catalyst. The second molecular sieve catalyst comprises a second noble metal and a second molecular sieve, wherein the second molecular sieve does not have an MAZ Framework Type. In this embodiment, the passive NOₓ adsorber may comprise one or more additional molecular sieve catalysts (e.g., a third molecular sieve catalyst and/or a fourth molecular sieve catalyst), provided that the additional molecular sieve(s) are different than the first and second molecular sieves.

The first noble metal and the second noble metal are independently selected from platinum, palladium, rhodium, gold, silver, iridium, ruthenium, osmium, or mixtures thereof; preferably, they are independently selected from palladium, platinum, rhodium, or mixtures thereof. More preferably, the first noble metal and the second noble metal are both palladium.

The second molecular sieve is preferably a small pore molecular sieve having the Framework Type of ACO, AEI, AEN, AFN, AFT, AFX, ANA, APC, APD, ATT, CDO, CHA, DDR, DFT, EAB, EDI, EPI, ERI, GIS, GOO, IHW, ITE, ITW, LEV, KFI, MER, MON, NSI, OWE, PAU, PHI, RHO, RTH, SAT, SAV, SFW, SIV, THO, TSC, UEI, UFI, VNI, YUG, and ZON, a medium pore molecular sieve having the Framework Type of MFI, FER, MWW, or EUO, a large pore molecular sieve having the Framework Type of CON, BEA, FAU, MOR, or EMT, as well as mixtures or intergrowths of any two or more. More preferably, the small pore zeolite is AEI or CHA, the medium pore zeolite is MFI, and the large pore zeolite is BEA.

The passive NOₓ adsorber containing the second molecular sieve catalyst may be prepared by processes well known in the prior art. The noble metal/MAZ-framework molecular sieve and the second molecular sieve catalyst may be physically mixed to produce the passive NOₓ adsorber. Preferably, the passive NOₓ adsorber further comprises a flow-through substrate or filter substrate. In one embodiment, the noble metal/MAZ-framework molecular sieve and the second molecular sieve catalyst are coated onto the flow-through or filter substrate, and preferably deposited on the flow-through or filter substrate using a washcoat procedure to produce the passive NOₓ adsorber.

Suitable flow-through or filter substrates are described above, as well as procedures for washcoating the substrates with the noble metal/MAZ-framework molecular sieve and the second molecular sieve catalyst. The order of addition of the noble metal/MAZ-framework molecular sieve and the second molecular sieve catalyst onto the flow-through or filter substrate is not considered critical. Thus, the noble metal/MAZ-framework molecular sieve may be washcoated on the substrate prior to the second molecular sieve catalyst or the second molecular sieve catalyst may be washcoated on the substrate prior to the noble metal/MAZ-framework molecular sieve or both the noble metal/MAZ-framework molecular sieve and the second molecular sieve catalyst can be washcoated on the substrate simultaneously.

In an alternative embodiment, the flow-through or filter substrate is comprised of the noble metal/MAZ-framework molecular sieve, the second molecular sieve catalyst, or both the noble metal/MAZ-framework molecular sieve and second molecular sieve catalyst. In this case, the noble metal/MAZ-framework molecular sieve, the second molecular sieve catalyst, or both are extruded to form the flow-through or filter substrate. If not included in the extruded substrate, the noble metal/MAZ-framework molecular sieve or second molecular sieve catalyst is coated onto the extruded flow-through or filter substrate. The extruded substrate is preferably a honeycomb flow-through monolith.

Preferably, the passive NOₓ adsorber comprises a first layer comprising the noble metal/MAZ-framework molecular sieve and a second layer comprising the second molecular sieve catalyst. Typically, the first layer may be disposed on a substrate and the second layer is disposed on the first layer. Alternatively, the second layer may be disposed on a substrate and the first layer disposed on the second layer.

In a separate embodiment, the passive NOₓ adsorber comprises a first zone comprising the noble metal/MAZ-framework molecular sieve and a second zone comprising the second molecular sieve catalyst. The first zone may be upstream of the second zone such that the first zone contacts the exhaust gas prior to the second zone, or alternatively the second zone may be upstream of the first zone such that the second zone contacts the exhaust gas prior to the first zone. Preferably, the second zone is located upstream of the first zone such that the exhaust gas contacts the second molecular sieve catalyst prior to contacting the first molecular sieve catalyst. The two zones may be on the same catalyst component (or catalyst brick), or the first zone comprising the noble metal/MAZ-framework molecular sieve may be located on a separate brick (or catalyst component) than the second zone comprising the second molecular sieve catalyst.

The invention also includes an exhaust system for internal combustion engines comprising the passive NOₓ adsorber. The exhaust system preferably comprises one or more additional after-treatment devices capable of removing pollutants from internal combustion engine exhaust gases at normal operating temperatures. Preferably, the exhaust system comprises the passive NOₓ adsorber and one or more other catalyst components selected from: (1) a selective catalytic reduction (SCR) catalyst, (2) a particulate filter, (3) a SCR filter, (4) a NOₓ adsorber catalyst, (5) a three-way catalyst, (6) an oxidation catalyst, or any combination thereof. The passive NOₓ adsorber is preferably a separate component from any of the above after-treatment devices.

Alternatively, the passive NOₓ adsorber can be incorporated as a component into any of the above after-treatment devices.

These after-treatment devices are well known in the art. Selective catalytic reduction (SCR) catalysts are catalysts that reduce NOₓ to N₂ by reaction with nitrogen compounds (such as ammonia or urea) or hydrocarbons (lean NOₓ reduction). A typical SCR catalyst is comprised of a vanadia-titania catalyst, a vanadia-tungsta-titania catalyst, or a metal/zeolite catalyst such as iron/beta zeolite, copper/beta zeolite, copper/SSZ-13, copper/SAPO-34, Fe/ZSM-5, or copper/ZSM-5.

Particulate filters are devices that reduce particulates from the exhaust of internal combustion engines. Particulate filters include catalyzed particulate filters and bare (non-catalyzed) particulate filters. Catalyzed particulate filters (for diesel and gasoline applications) include metal and metal oxide components (such as Pt, Pd, Fe, Mn, Cu, and ceria) to oxidize hydrocarbons and carbon monoxide in addition to destroying soot trapped by the filter.

Selective catalytic reduction filters (SCRF) are single-substrate devices that combine the functionality of an SCR and a particulate filter. They are used to reduce NOₓ and particulate emissions from internal combustion engines. In addition to the SCR catalyst coating, the particulate filter may also include other metal and metal oxide components (such as Pt, Pd, Fe, Mn, Cu, and ceria) to oxidize hydrocarbons and carbon monoxide in addition to destroying soot trapped by the filter.

NOₓ adsorber catalysts (NACs) are designed to adsorb NOₓ under lean exhaust conditions, release the adsorbed NOₓ under rich conditions, and reduce the released NOₓ to form N₂. NACs typically include a NOₓ-storage component (e.g., Ba, Ca, Sr, Mg, K, Na, Li, Cs, La, Y, Pr, and Nd), an oxidation component (preferably Pt) and a reduction component (preferably Rh). These components are contained on one or more supports.

Three-way catalysts (TWCs) are typically used in gasoline engines under stoichiometric conditions in order to convert NOₓ to N₂, carbon monoxide to CO₂, and hydrocarbons to CO₂ and H₂O on a single device.

Oxidation catalysts, and in particular diesel oxidation catalysts (DOCs), are well-known in the art. Oxidation catalysts are designed to oxidize CO to CO₂ and gas phase hydrocarbons (HC) and an organic fraction of diesel particulates (soluble organic fraction) to CO₂ and H₂O. Typical oxidation catalysts include platinum and optionally also palladium on a high surface area inorganic oxide support, such as alumina, silica-alumina and a zeolite.

The passive NOₓ adsorber is preferably a separate component from any of the above after-treatment devices. Alternatively, the passive NOₓ adsorber can be incorporated as a component into any of the above after-treatment devices. For instance, a substrate may comprise and upstream zone of the passive NOₓ adsorber and a downstream zone of SCR catalyst on the same substrate.

The exhaust system can be configured so that the passive NOₓ adsorber is located close to the engine and the additional after-treatment device(s) are located downstream of the passive NOₓ adsorber. Thus, under normal operating conditions, engine exhaust gas first flows through the passive NOₓ adsorber prior to contacting the after-treatment device(s). Alternatively, the exhaust system may contain valves or other gas-directing means such that during the low temperature period (below a temperature ranging from about 150 to 220° C., preferably 200° C., about as measured at the after-treatment device(s)), the exhaust gas is directed to contact the after-treatment device(s) before flowing to the passive NOₓ adsorber. Once the after-treatment device(s) reaches the operating temperature (about 150 to 220° C., preferably 200° C., as measured at the after-treatment device(s)), the exhaust gas flow is then redirected to contact the passive NOₓ adsorber prior to contacting the after-treatment device(s). This ensures that the temperature of the passive NOₓ adsorber remains low for a longer period of time, and thus improves efficiency of the passive NOₓ adsorber, while simultaneously allowing the after-treatment device(s) to more quickly reach operating temperature. U.S. Pat. No. 5,656,244, the teachings of which are incorporated herein by reference, for example, teaches means for controlling the flow of the exhaust gas during cold-start and normal operating conditions.

The invention also includes a method for treating exhaust gas from an internal combustion engine. The method comprises adsorbing NOₓ onto the passive NOₓ adsorber at temperatures at or below a low temperature, thermally desorbing NOₓ from the passive NOₓ adsorber at a temperature above the low temperature, and catalytically removing the desorbed NOₓ on a catalyst component downstream of the passive NOₓ adsorber. Preferably, the low temperature is about 250° C.

The catalyst component downstream of the passive NOₓ adsorber is a SCR catalyst, a particulate filter, a SCR filter, a NOₓ adsorber catalyst, a three-way catalyst, an oxidation catalyst, or combinations thereof.

The following examples merely illustrate the invention. Those skilled in the art will recognize many variations that are within the spirit of the invention and scope of the claims.

### EXAMPLE 1

### Preparation of Passive NOₓ Adsorbers (PNAs) of the Invention

Preparation of MAZ Zeolite

A reaction gel (molar composition 60 SiO₂: 3Al₂O₃: 12.5Na₂O: 15 template: 3000 H₂O) is prepared in a 19 Liter autoclave, as follows. Colloidal silica (30%w/w colloidal silica; Grace Davison) is charged to autoclave and the stirrer is started at 300 rpm. Template (choline hydroxide; 46% aq. Solution) is then dispersed in 40% of the free water and charged to the autoclave. The required amounts of sodium aluminate (42.4% Na₂O, 54.9% Al₂O₃; Alfa-Aesar) and sodium hydroxide are dissolved in 40% of the free water and charged to the autoclave. The charging line is then flushed through with remaining 20% of the free water. Once all the reagents are charged, the autoclave is sealed and then pressurized with nitrogen to about 20 psi and the heating switched on with a set point of 150° C. The autoclave is left stirring at 150° C. for approximately 3 days. After approximately 3 days at reaction temperature, the autoclave is cooled, vented and discharged. The resulting material is filtered under vacuum and washed using twice its volume of de-mineralized water. The resulting product is dried overnight at 110° C. Analysis by powder XRD indicates that the product is phase pure.

Prior to its use in catalyst preparation, the as-made zeolite is activated by calcining, in air, by heating to 110° C. at 2° C./min then heated to 450° C. at 5° C./min and held at 450° C. for 16 hours. Finally the material is heated to 550° C. at 5° C./min at held at 550° C. for 16 hours. Once the material cools to room temperature, it is ion-exchanged with a 1 molar solution of ammonium chloride using 10 mL of solution per gram of calcined zeolite. The ion-exchange is carried out with stirring at room temperature for 1 hour. Agitation is stopped and the slurry centrifuged. The clear supernatant is decanted off. The ion-exchange procedure is then repeated following which the zeolite is centrifuged and washed (supernatant decanted off) then dried. The resulting NH₄-form zeolite is converted to the H-form by calcining, in air, by heating to 150° C. at 2° C./min and holding at 150° C. for 10 hours followed by heating to 450° C. at 5° C./min with a final hold at 450° C. for 16 hours. Analysis by XRF shows the H-form zeolite to have the composition: 9.2SiO₂—Al₂O₃-0.01Na₂O.

PNA 1A: 1 wt. % Pd/MAZ

Palladium is added to MAZ zeolite with a silica-to-alumina ratio (SAR) of 9.2 according to the following procedure to produce PNA 1A: The powder catalyst is prepared by wet impregnation of the zeolite using a soluble palladium compound as the precursor. After drying at 105° C., the sample is calcined at 500° C. to provide the fresh catalyst, and a portion of the fresh catalyst is then hydrothermally aged at 750° C. in an air atmosphere containing 10% H₂O. The Pd loading of PNA 1A is 1 wt. %.

PNA 1B: 3% Pd/MAZ

PNA 1B is produced using the same procedure as PNA 1A with the exception that the amount of soluble palladium compound is increased to result in higher Pd loading. The Pd loading of PNA 1B is 3 wt.%.

### EXAMPLE 2

### Preparation of Comparative PNAs

Comparative PNA 2A: 1 wt.% Pd/CHA

Comparative PNA 2A is produced using the same procedure as PNA 1A with the exception that a small pore chabazite (CHA) zeolite with a silica-to-alumina ratio (SAR) of 25 is used in place of MAZ. The Pd loading of Comparative PNA 2A is 1 wt.%.

Comparative PNA 2B: 3 wt.% Pd/CHA

Comparative PNA 2B is produced using the same procedure as PNA 1B with the exception that a small pore chabazite (CHA) zeolite with a silica-to-alumina ratio (SAR) of 25 is used in place of MAZ. The Pd loading of Comparative PNA 2B is 3 wt.%.

### EXAMPLE 2

### NOₓ Storage Capacity Testing Procedures

The catalyst (0.4 g) is held at the adsorption temperature of about 100° C. for 5 minutes in an NO-containing gas mixture flowing at 2 liters per minute at a MHSV of 300 L*hr⁻¹*g⁻¹. This adsorption stage is followed by Temperature Programmed Desorption (TPD) at a ramping rate of 17° C./minute in the presence of the NO-containing gas until the bed temperature reaches about 450° C. in order to purge the catalyst of all stored NOₓ for further testing.

The NO-containing gas mixture during both the adsorption and desorption comprises 10 vol. % O₂, 60 ppm NO, 5 vol. % CO₂, 1500 ppm CO, 130 ppm C₃H₆, and 5 vol. % H₂O in N₂.

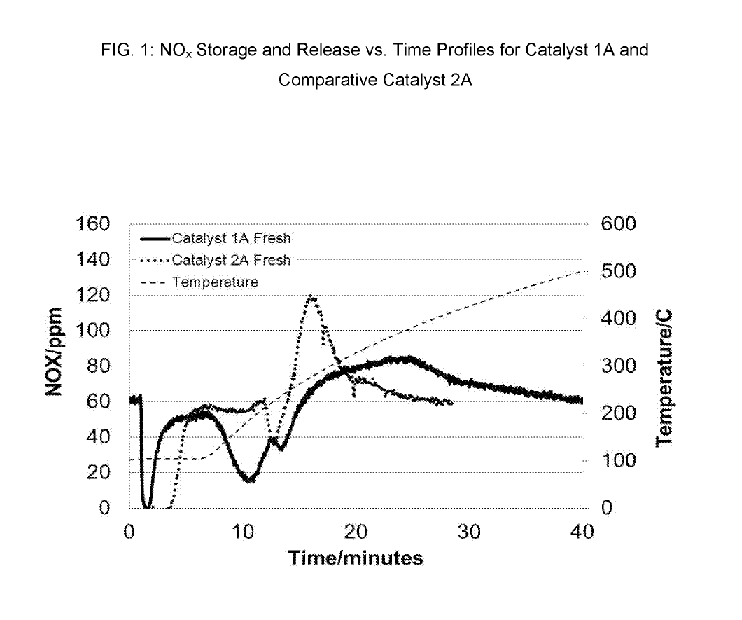

The NOₓ storage is calculated as the amount of NO₂ stored per liter of catalyst with reference to a monolith containing a catalyst loading of about 3 g/in³. The results at the different temperatures are shown in Table 1 and the NOx uptake and release profiles are shown in FIG. 1.

The results at Table 1 show that the PNAs of the invention (PNA 1A and PNA 1B) store a greater amount of NOₓ compared to the Comparative PNAs over the entire testing period. Although at the initial 100° C. storage period the NOx storage of the Pd/CHA samples was higher than that of the Pd/MAZ samples, during the temperature ramping period above 100° C. the Pd/MAZ samples store more NOₓ than the comparative Pd/CHA samples as shown in FIG. 1. Additionally, the Pd/MAZ catalysts release NOₓ over a broad temperature range and at a higher temperature than Pd/CHA as is also shown in FIG. 1. The NO release characteristics are maintained following hydorthermal aging as shown in Table 1.

TABLE 1
NOₓ Storage Comparison Results

| | | | NOₓ storage | | |
|---|---|---|---|---|---|
| | | | capacity at | | |
| | | | 100° C. until | NOₓ release | NOₓ release |
| | | | break- | onset | peak |
| | | Pd | through¹ | temperature | temperature |
| Catalyst | Zeolite | loading | (g NO₂/L) | (° C.) | (° C.) |
| 1A Fresh | MAZ | 1 wt % | 0.68 | 260 | 350 |
| 1B Fresh | MAZ | 3 wt % | 1.13 | 260 | 350 |
| 2A Fresh | CHA | 1 wt % | 0.51 | 230 | 260 |
| 2B Fresh | CHA | 3 wt % | 0.70 | 260 | 330 |
| 1A Aged | MAZ | 1 wt % | 0.45 | 260 | 350 |
| 2A Aged | CHA | 1 wt % | 0.64 | 220 | 255 |

¹“Breakthrough” is defined as the temperature at which the concentration of NOₓ in the gas stream rises above the initial inlet value of 60 ppm.

We claim:

1. A passive NOₓ adsorber effective to adsorb NOₓ at or below a low temperature and release the adsorbed NOₓ at temperatures above the low temperature, said passive NOₓ adsorber comprising a first noble metal and a molecular sieve having a MAZ Framework Type.

2. The passive NOₓ adsorber of claim 1 wherein the first noble metal is selected from the group consisting of platinum, palladium, rhodium, gold, silver, iridium, ruthenium, osmium, and mixtures thereof.

3. The passive NOₓ adsorber of claim 1 wherein the first noble metal is palladium.

4. The passive NOₓ adsorber of claim 1 wherein the molecular sieve having a MAZ Framework Type is selected from the group consisting of aluminosilicate zeolite and a metal-substituted aluminosilicate zeolite.

5. The passive NOₓ adsorber of claim 1 wherein the molecular sieve having a MAZ Framework Type is selected from the group consisting of ZSM-4, LZ-202, mazzite, and omega zeolite.

6. The passive NOₓ adsorber of claim 1 wherein the passive NOₓ adsorber is coated onto a flow-through or filter substrate.

7. The passive NOₓ adsorber of claim 1 wherein the passive NOₓ adsorber is extruded to form a flow-through or filter substrate.

8. The passive NOₓ adsorber of claim 1 further comprising a second molecular sieve catalyst, wherein the second molecular sieve catalyst comprises a second noble metal and a second molecular sieve, wherein the second molecular sieve does not have an MAZ Framework Type.

9. The passive NOₓ adsorber of claim 8 wherein the first noble metal and the second noble metal are independently selected from the group consisting of platinum, palladium, rhodium, gold, silver, iridium, ruthenium, osmium, and mixtures thereof.

10. The passive NOₓ adsorber of claim 8 wherein the first noble metal and the second noble metal are both palladium.

11. The passive NOₓ adsorber of claim 8 wherein the second molecular sieve is a small, medium or large pore molecular sieve selected from the group of Framework Type consisting of ACO, AEI, AEN, AFN, AFT, AFX, ANA, APC, APD, ATT, CDO, CHA, DDR, DFT, EAB, EDI, EPI, ERI, GIS, GOO, IHW, ITE, ITW, LEV, KFI, MER, MON, NSI, OWE, PAU, PHI, RHO, RTH, SAT, SAV, SFW, SIV, THO, TSC, UEI, UFI, VNI, YUG, ZON, BEA, and MFI, and intergrowths of two or more.

12. The passive NOₓ adsorber of claim 11 wherein the small pore molecular sieve is selected from the group Framework Type consisting of AEI and CHA.

13. The passive NOₓ adsorber of claim 8 wherein the passive NOₓ adsorber is coated onto a flow-through or filter substrate.

14. The passive NOₓ adsorber of claim 8 having a first layer and a second layer wherein the first layer comprises the first noble metal and the molecular sieve having a MAZ Framework Type and the second layer comprises the second molecular sieve catalyst.

15. The passive NOₓ adsorber of claim 8 having a first zone and a second zone wherein the first zone comprises the first noble metal and the molecular sieve having a MAZ Framework Type and the second zone comprises the second molecular sieve catalyst.

16. The passive NOₓ adsorber of claim 1 wherein the low temperature is 250° C.

17. An exhaust system for internal combustion engines comprising the passive NOₓ adsorber of claim 1 and a catalyst component selected from the group consisting a selective catalytic reduction (SCR) catalyst, a particulate filter, a SCR filter, a NOₓ adsorber catalyst, a three-way catalyst, an oxidation catalyst, and combinations thereof.

18. A method for reducing NOₓ in an exhaust gas, said method comprising adsorbing NOₓ onto the passive NOₓ adsorber of claim 1 at or below a low temperature, thermally desorbing NOₓ from the passive NOₓ adsorber at a temperature above the low temperature, and catalytically removing the desorbed NOₓ on a catalyst component downstream of the passive NOₓ adsorber.

19. The method of claim 18 wherein the catalyst component is selected from the group consisting a selective catalytic reduction (SCR) catalyst, a particulate filter, a SCR filter, a NOₓ adsorber catalyst, a three-way catalyst, an oxidation catalyst, and combinations thereof.

20. The method of claim 18 wherein the low temperature is 250° C.
